(19) United States
(12) Patent Application Publication
(10) Pub. No.: US 2025/0124814 A1
(43) Pub. Date: Apr. 17, 2025

(54) MODULAR INTRAOSSEOUS INFUSION TRAINING ADJUNCT AND SYSTEM

(71) Applicant: MOCHTECH, LLC, Grover, MO (US)

(72) Inventors: Robb Mourton, Grover, MO (US); Wesley Mourton, Ballwin (JS)

(73) Assignee: MOCHTECH, LLC, Grover, MO (US)

(21) Appl. No.: 18/914,434

(22) Filed: Oct. 14, 2024

Related U.S. Application Data
(60) Provisional application No. 63/544,023, filed on Oct. 13, 2023.

(51) Int. Cl. G09B 23/28

(52) U.S. Cl. CPC G09B 23/285

(57) ABSTRACT

A modular Intraosseous Infusion training adjunct that attaches to a medical training device, such as a MITS™ Platform, where the training device has an orifice therein. The adjunct has a body with a substantially rigid insertion training area that replicates human bone tissue. The adjunct releasably attaches to the medical training device in such a way that the insertion training area is positioned over the medical device orifice when said adjunct is attached to the training device.

### CROSS REFERENCE TO RELATED APPLICATIONS

This application derives and claims priority from U.S. provisional application 63/544,023, filed Oct. 13, 2023, and having Attorney Docket No. MOCH H015US, which provisional application is incorporated herein by reference.

### STATEMENT REGARDING FEDERALLY SPONSORED RESEARCH OR DEVELOPMENT

Not Applicable.

### FIELD

The present teachings generally relate to medical training devices, and more particularly to a modular Intraosseous Infusion training apparatus and associated components.

### BACKGROUND

The statements in this section merely provide background information related to the present disclosure and may not constitute prior art.

Intraosseous (often referred to as “IO”) Infusion is the process of injecting medications, fluids and/or blood products directly into the marrow of a bone. This technique provides a non-collapsible entry point into the patient's systemic venous system. IO Infusion provides parenteral access that is generally considered relatively fast and easy to implement, contrasting with intravenous (“IV”) access that can at times prove difficult. For example, IO Infusion is currently recommended as an option for patients with out-of-hospital cardiac arrest when IV access cannot be immediately obtained.

Learning the proper skill and precision for safely and effectively performing an IO Infusion procedure on a patient, particularly an IO Infusion that is to be performed in emergency situations, can be a difficult and onerous process. Such training becomes more complex and complicated when the training must occur at home or under field conditions, i.e., at locations other than established medical training facilities such as for example at temporary and/or mobile military medical facilities or bases.

Medical personnel whose job responsibilities include performing IO Infusion procedures on patients must be trained and certified for that skill set. Those skill sets also require regular practice to maintain proficiency and recertification. In addition, in emergency situations or in military battlefield circumstances, a proper IO Infusion procedure can mean the difference between life and death for an injured patient. That is, proper and effective IO Infusion training can prepare a medical responder to timely and properly treat a leading cause of preventable death in a traumatic emergency—i.e., suffocation due to a blocked airway in the throat. Consequently, in addition to benefitting medical personnel in performing routine IO Infusion procedures, ongoing training and practice of proper IO Infusion procedure techniques by emergency responders and troops is therefore critically important.

Traditional IO Infusion training devices are designed for classroom settings. They typically include a replicated human body part (e.g., a head and neck, or torso), and focus on anatomical correctness—not convenience. Most require support components (e.g., pumps and monitors) that link to the anatomical component with tubes and wires. Traditional IO Infusion trainers are therefore bulky and cumbersome, not very durable or very portable, and not well-suited for home use or for field training conditions. Up to recently, the prevailing attitude in the medical community had been that the student would learn and practice IO Infusion techniques at an institution or facility supplied with a traditional training device. As a consequence, training, certification and recertification efforts have been traditionally focused on classroom training, with few options for home or other out-of-classroom practice.

Moreover, traditional IO Infusion training components are almost uniformly “stand alone.” That is, they are produced as an individual training device to be used only for IO Infusion training, and cannot be used for other purposes or in conjunction with other medical training devices. However, typically, individuals learning IO Infusion procedures will also have a need for training in other medical treatment techniques, such as for example, various medical needle insertions techniques. Traditional IO Infusion trainers are not designed for such cross-training purposes.

Recently, a few “portable” or “personal” medical training devices have been introduced, including for example the self-contained needle insertion training systems disclosed in U.S. Pat. Nos. 8,556,634, 8,808,005, 10,380,918 and 10943,,507 (collectively, the “MITS™ Patents”). Such training systems are stand-alone devices that are designed to either augment or for use in conjunction with traditional classroom training programs. However, the devices covered by the MITS™ Patents have not been capable of providing IO Infusion training.

It therefore would be desirable to have a IO Infusion training device that can be used in a traditional classroom setting or as a portable or take-home trainer that can be used in conjunction with classroom training or a classroom trainer, and/or can be used in conjunction with a needle insertion training system, such as for example, the devices covered by the MITS™ Patents.

### BRIEF DESCRIPTION OF SEVERAL VIEWS OF THE DRAWINGS

The illustrative embodiments of the present invention are shown in the following drawings which form a part of the specification. The drawings described herein are for illustration purposes only and are not intended to limit the scope of the present teachings in any way.

FIG. 1 is a perspective view of a representative first embodiment of an IO Infusion training simulated bone segment adjunct in accordance with the present disclosure.

FIG. 2 is an alternate perspective view of the IO Infusion training adjunct of FIG. 1.

FIG. 3 is an underside perspective view of the IO Infusion training adjunct of FIG. 1, with the injection plate removed from the clip and positioned proximate the training adjunct body.

FIG. 4 is a top view of the IO Infusion training adjunct of FIG. 1 attached to a representative MITS™ medical needle training device with the adjunct injection plate inserted in the adjunct body.

FIG. 5 is an exploded perspective view of the representative MITS™ medical needle training device of FIG. 4 in isolation.

FIG. 6 is an assembled perspective view of the representative MITS™ medical needle training device of FIG. 5, showing the training orifice in phantom lines.

FIG. 7 is a perspective view of the IO Infusion training adjunct and MITS™ medical needle training device of FIG. 4, with one of the MITS™ endcaps removed.

FIG. 8 is a top view of the IO Infusion training adjunct and MITS™ medical needle training device of FIG. 4, with one of the MITS™ endcaps removed and the adjunct insertion plate partially removed from the adjunct body.

FIG. 9 is a side view of the IO Infusion training adjunct and MITS™ medical needle training device of FIG. 4, with simulated skin covering the adjunct and an IO needle assembly anchored vertically in the adjunct insertion plate under the simulated skin and into the training orifice of the MITS™, the IO needle assembly comprising a catheter in the lower end of the assembly.

FIG. 10 is a perspective view of FIG. 9, with the IO needle assembly catheter exposed and attached to a fluid tube, and showing an associated IO drill next to the MITS™.

FIG. 11 is a side view of FIG. 10, without the associated IO drill.

Corresponding reference numerals indicate corresponding parts throughout the several views of drawings.

### DETAILED DESCRIPTION

The following description is merely representative in nature and is not intended to limit the present disclosure or the disclosure's applications or uses. Before turning to the figures and the various representative embodiments illustrated therein, a detailed overview of various embodiments and aspects is provided for purposes of breadth of scope, context, clarity, and completeness. Further areas of applicability of the present teachings will become apparent from the description provided herein. It should be understood that the description and specific examples are intended for purposes of illustration only and are not intended to limit the scope of the present teachings.

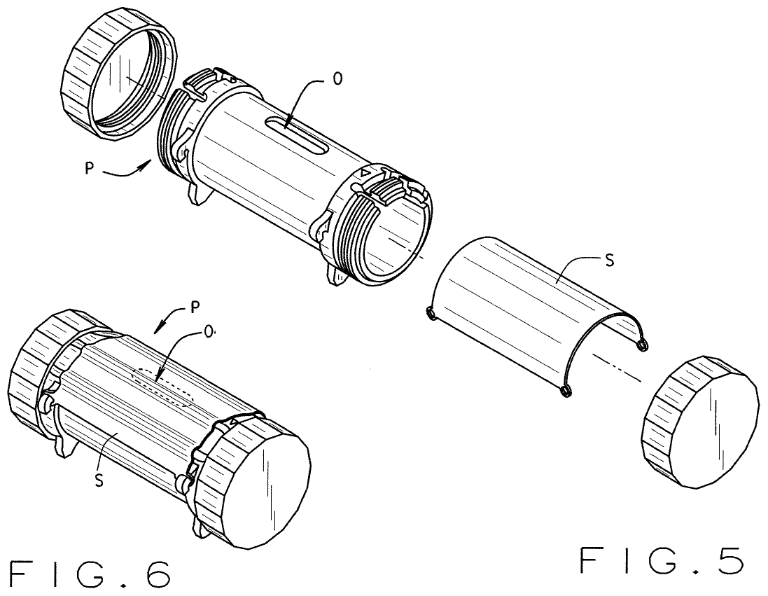

As described and disclosed herein are improvements to embodiments of a modular Intraosseous (“IO”) Infusion training component or adjunct 10 for a medical trainer Platform, such as the self-contained needle insertion training platform as disclosed, for example, in U.S. Pat. No. 10,943,507 (hereinafter, the “MITS™ Platform”), which disclosure is incorporated by reference herein. A representative MITS™ Platform P is depicted in FIGS. 5-6, and in attachment to a representative adjunct 10 in FIGS. 4, 7-11. Generally, a self-contained needle insertion training device such as for example the MITS™ Platform P, provides expedient and precise skills training for various medical needle insertion techniques, including for example, intravenous (“IV”), intramuscular, subcutaneous and needle decompression. In various embodiments, the MITS™ Platform P includes a rigid hollow body having at least one sidewall with a training region having an elongated training port or orifice O, with the sidewall defining an interior chamber. The MITS™ Platform P is configured to utilize the orifice O for one or more needle insertion training procedures. The body is cylindrical and approximately two to three inches in diameter and approximately six inches long. The MITS™ Platform P additionally includes a removable elastic skin patch S that covers the training orifice O in the sidewall. One or more simulated cardiovascular veins or arteries can be disposed along an outer surface of the sidewall under the skin patch. It is envisioned that the MITS™ Platform P can be used, for example, in the field by military forces to instruct critical combat lifesaving skills to soldiers and host nation forces, as well as providing an excellent commercial training tool for personal use as well as in the classroom setting, and may be used as a foundational component in conjunction with the MITS™ modular system. In particular, the MITS™ Platform P is be sized to approximate the average size of a human forearm or wrist, and by happenstance the front portion of a human throat, such that the Platform can be securely held and stabilized with one hand of the user, leaving the user's other hand free to practice IO Infusion training techniques described herein.

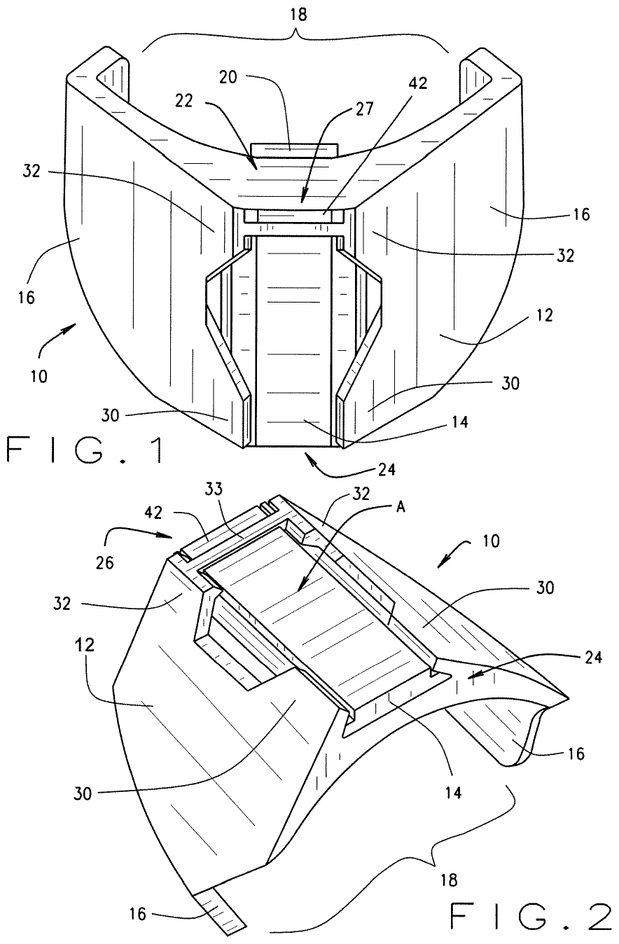

Referring now to FIGS. 1-3, the present disclosure provides a modular IO Infusion training adjunct 10 that comprises a saddle-shaped body 12 and a removable insertion plate 14 that snaps into the top of the body 12. Collectively, the upper portion of the body 12 and the insertion plate 14 form a simulated anterior aspect of a human bone segment 12. The modular adjunct 10 is preferably formed with one or more substantially rigid, though somewhat pliant, polymers that can be produced by 3D printing techniques.

The body 12 is a semicircular shell that is approximately 0.125 inch thick, approximately 1.75 inches long, approximately 2.25 inches wide, and has a radius of curvature of approximately 1.0 inches. The body 12 has two generally rectangular curved flanges 16 that each extend perpendicularly downward from and longitudinally along one of the two sides of body 12. The flanges 16 are each approximately 0.625 inches long and 0.75 inches wide, and continue the curvature of the portion of the body 12 from which they extend, to collectively form a pliant clamp or clip 18 there between.

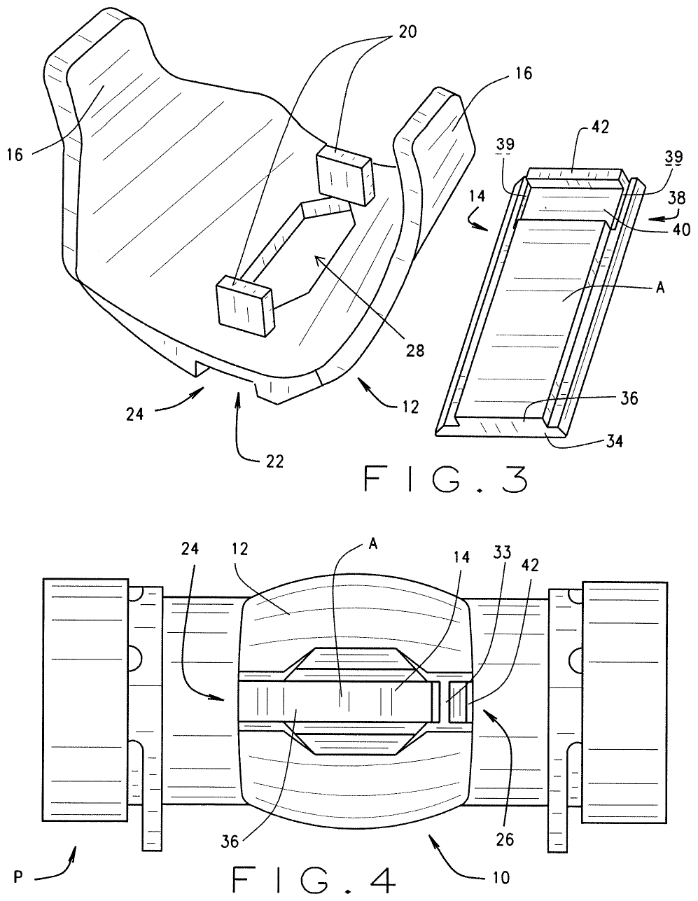

The underside of body 12 includes a pair of laterally-oriented positional tabs 20. Each of the positional tabs 20 is approximately 0.375 inches wide, 0.25 inches long, and 0.125 inches thick. The tabs 20 each extend in a perpendicular fashion downward from the underside of the body 12, are substantially parallel to one another, and each is positioned approximately 0.25 inches from its respected end of the body 12. The tabs 20 are positioned and oriented to slip into and mate with the edges at each end of the training orifice O in a MITS™ Platform P. (See FIGS. 3-4). The tabs 20 thereby ensure proper alignment of the body 12 to the MITS™ Platform P. Further, the tabs 20 can alternatively be configured to “snap” into the training orifice O of an associated MITS™ Platform P to secure the modular adjunct 10 in the MITS™.

Referring again to FIGS. 2 and 3, it can be seen that the body 12 includes a longitudinal slot 22 that is oriented along, and extends nearly the full length of, the top of the body 12. Slot 22 has a uniform generally trapezoidally-shape. The base of the slot 22 has a width of approximately 0.75 inches, a top width of approximately 0.625 inches, and a height of 0.094 inches. The slot 22 has an open end 24 and a closed end 26. The closed end 26 has a horizontally-oriented rectangular opening 27 that is centered on the midpoint of the slot 22. The opening 27 is just under 0.125 inches tall and is approximately 0.375 inches wide. A first set of opposing prongs 30 extend angularly above the slot 22 proximate the open end 24, while a second set of matching opposing prongs 32 extend angularly above the slot 22 at the closed end 26. Each of the prongs 30 is separated by a gap of approximately 0.375 inches. Likewise, each of the prongs 32 is separated by a gap of approximately 0.375 inches. A slim, rectangular horizontal cross-brace 33, having a width of approximately 0.175 inches, extends across the top of the second prongs 32 proximate the closed end 26 of the slot 22.

In addition, the body 12 has an elongated longitudinal slit 28 that is positioned below and along the center of the slot 22, and is positioned lengthwise centered between the positional tabs 20. The slit 28 is approximately 1.125 inches long, 0.375 inches wide, and has triangular-shaped ends.

The insertion plate 14 is approximately 1.75 inches long by just under 0.75 inches wide, and is sized and shaped to fit snugly into slot 22 while also extending above the slot 22 and into the underside of the prongs 30 and 32. That is, the cross-section of the insertion plate 14 has a uniform generally trapezoidally-shaped base 34 with a smaller stepped rectangular protrusion 36 centered along the top of the base 34, so as to fit snugly between the prongs 30 and between the prongs 32. Consequently, the insertion plate base 34 has a bottom width of just under 0.75 inches, a top width of just under 0.625 inches, and a thickness of just under 0.094 inches. Further, the rectangular protrusion 36 has a substantially uniform width of approximately 0.375 inches and a substantially uniform thickness of approximately 0.0625 inches.

The top of the protrusion includes a training area A. Although the training area A preferably extends over the complete top of the protrusion 36, the functionality of the training area A will be limited to the zone defined by the perimeter of the opening in the body 12 under the insertion plate 14, such as for example the slit 28 of the body 12, when the plate 14 is properly attached to the body 12.

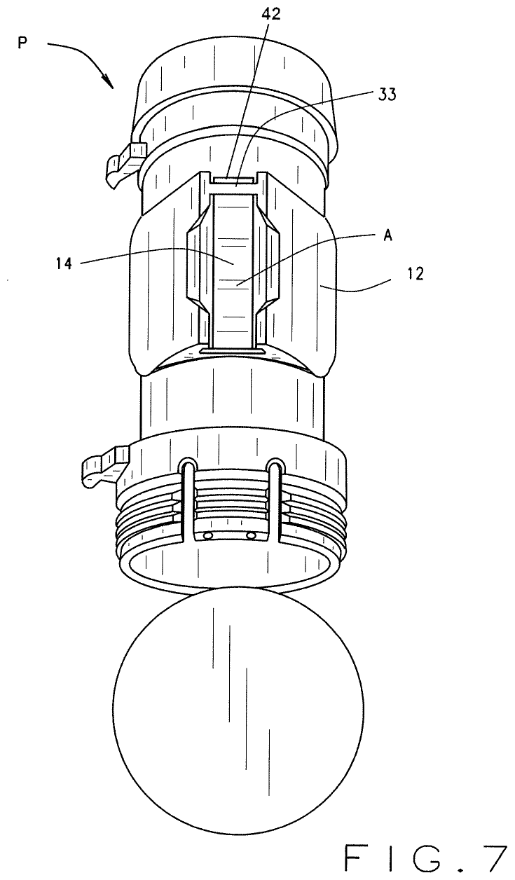

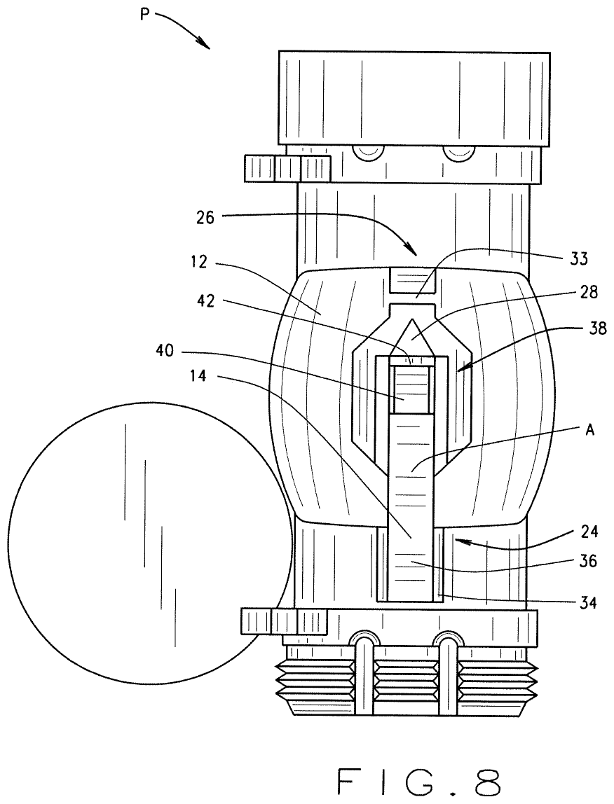

In addition, the insertion plate 14 has a distal end 38 with two parallel longitudinal slits 39 having equal lengths of approximately 0.375 inch that define a plaint tab 40 at said distal end 38 of the insertion plate 14. The tab 40 has a width of approximately 0.375 and includes a slightly raised ridge 42 along its distal end that allows the insertion plate 14 to engage the cross-brace 33 so as to “snap” into the slot 22. However, the tab 40 is sufficiently pliant such that with a moderate amount of force applied to the insertion plate 14, the retaining force provided by the ridge 42 can be overcome and the insertion plate 14 can be readily removed from the slot 22. (See comparative positioning of insertion plate 14 in FIGS. 7, 8).

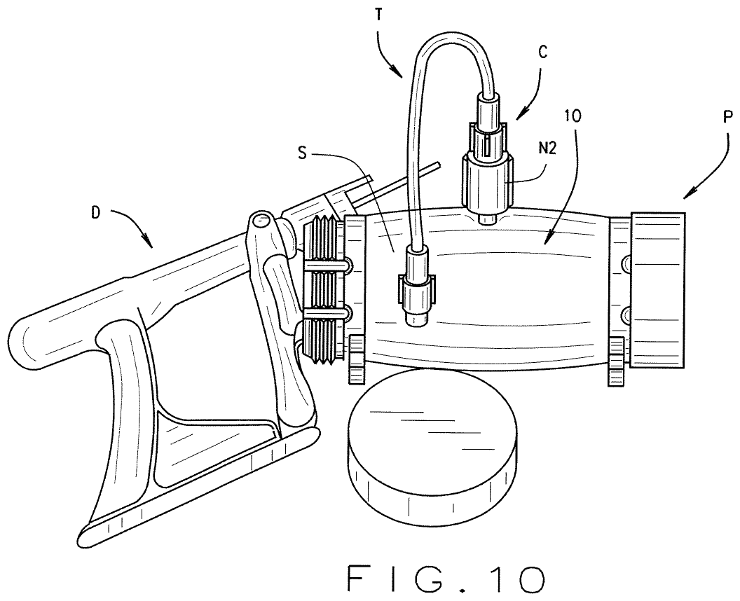

As can be seen and appreciated by one of ordinary skill in the art, and as depicted in FIGS. 4, 7-8, the modular adjunct 10 is designed to releasably attach to a MITS™ Platform P. As can also be appreciated, when the modular adjunct 10 is properly attached (i.e., “clipped”) to the top of the MITS™ Platform P, with the tabs 20 inserted into each end of the elongated orifice O, the training area A of insertion plate 14 will be substantially positioned over the orifice O. In this way, an IO drill, such as for example a drill D shown in FIG. 10 (or other similar device), can be used to bore holes through the training area A insertion plate 14 and into the orifice O for training purposes.

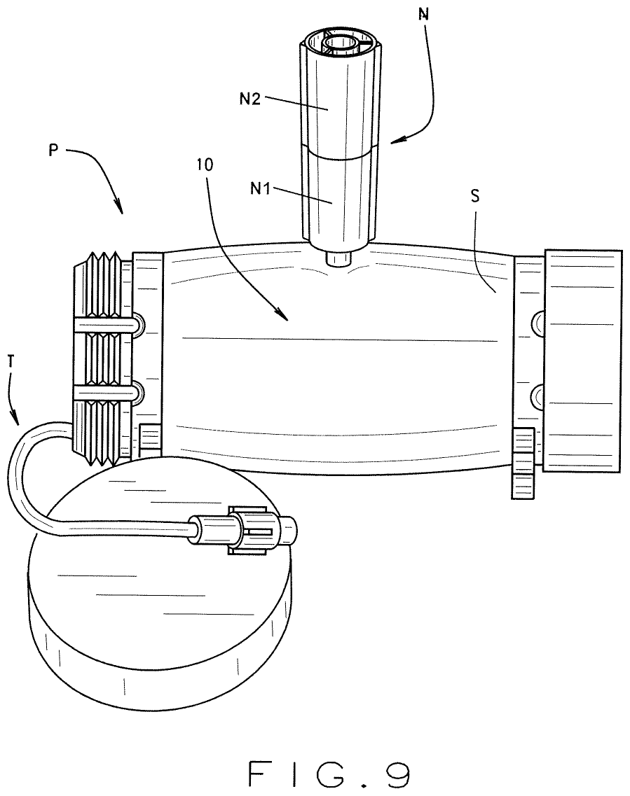

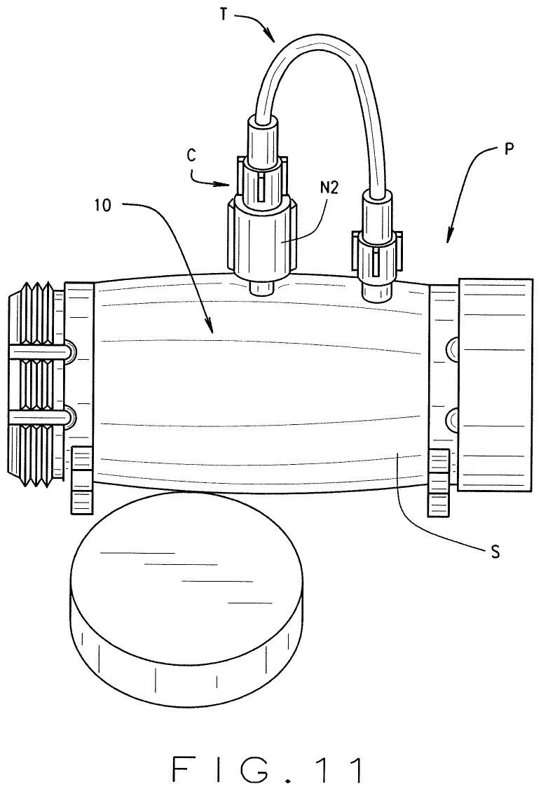

Referring now to FIGS. 9-11, it can be seen that the adjunct 10 is attached to a representative MITS™ Platform P to enable IO Training with a representative IO drill D, a representative IO needle assembly N, and a representative IO fluid tube T. The assembly N includes a lower portion N1 that houses a catheter C, and an upper portion N2 that attaches to the drill D and includes a puncture tip D for penetrating human bone. Once the puncture tip D has fully penetrated the training area A of the insertion plate 14, and the bottom of the assembly N is pushed against the top of the skin patch S atop the insertion plate 14, a small fluid insertion port is thereby formed in the plate 14. The upper portion N2 (along with the puncture tip D) of the assembly N is then separated and removed from the lower portion N1 to expose the catheter C in the lower portion N1 (see FIGS. 10-11). A fluid tube, such as the tube T can then be attached to the catheter C to simulate preparation for IO fluid injection.

This positioning of the modular adjunct 10 on the MITS™ Platform P allows the use of various IO Infusion tools (such as for example, one or more of a IO tube T or IO Infusion catheter C, as shown in FIGS. 9-11) in association with the modular adjunct 10 to facilitate the insertion of the IO tube T or IO Infusion catheter C through the bore in the modular adjunct 10 and through the training orifice O of the MITS™ Platform P, and into the body of the Platform, for emergency IO Infusion training, as also depicted in FIGS. 9-11. Thus, the modular adjunct 10 acts as an optional complementary accessory to, and utilizes the features of, a medical training device (such as the MITS™ Platform P) to which it releasably attaches.

In addition, when modular adjunct 10 is properly attached to the MITS™ Platform P, one or more simulated tissue or skin patches, such as the simulated skin patch S depicted in FIGS. 5-6, 9-11, can be placed over the modular adjunct 10 to further simulate the tissue of a human arm or leg to enhance the simulation of a human appendage for emergency IO Infusion training purposes. Preferably, the simulated tissue or skin patch or patches, such as the simulated skin S, should be slightly stretched over the modular adjunct 10 and attached to the MITS™ Platform P, such as for example as can be accomplished using the skin patch disclosed in U.S. patent application Ser. No. 16/046,724.

While we have described in the detailed description several configurations that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel mechanisms of the present invention, shown by way of example at 10 can be arranged in a number of other and related varieties of configurations without departing from or expanding beyond the scope of our invention as set forth in the claims. Thus, the description herein is merely exemplary in nature and variations that do not depart from the gist of that which is described are intended to be within the scope of the teachings. Such variations are not to be regarded as a departure from the spirit and scope of the teachings.

For example, the modular adjunct 10 can be configured to attach to other medical training devices that have an opening or orifice that is sized and shaped to receive, for example, an IO tube or IO Infusion catheter, through the modular adjunct 10 when the modular adjunct 10 is attached to such a device.

Further, while it is preferred that the adjunct 10 be configured such that all of the training area A is positioned over the orifice O, it is recognized that the adjunct 10 can alternatively be configured such that only a portion of the training area A will be oriented above the orifice O.

Also, the interface between the insertion plate 14 and the body 12 is not limited to the specific configuration disclosed above in the embodiment 10. That is, the plate 14 and body 12 can have a variety of alternative configurations recognizable to one of ordinary skill in the art that would enable the plate 14 to attach to the body 12. Such interfaces may include, for example, a press fit between the body 12 and the plate 14, or screws or latches or nuts that tighten the plate 14 to the body 12, or a separate attachment device that attaches the plate 14 to the body 12, or a hinge, a snap fit, or a positional grip. Further, the adjunct 10 (i.e., the body 12 and the plate 14) can be configured such that the plate 14 can be positioned against the body 12 in a manner that requires no attachment, but instead the body 12 simply “holds” the plate 14 in place during the IO training.

Also, the insertion plate 14 is not limited to the shape and size depicted in the Figures, but may have various sizes and shapes, so long as the insertion plate 14 is configured such that it will function substantially and provide the benefits as outlined in this disclosure.

In addition, adjunct 10 is not limited to having a single removable insertion plate 14. Rather, for example, there may comprise multiple insertion plates of the same or of varying configurations that attach to the body 12, which together may be part of a resupply kit. By way of further example, both the body 12 and the insertion plate 14 can each have a variety of shapes and sizes, so long as the insertion plate 14 can be attached to the body 12. Similarly, the body 12 can have a variety of shapes and sizes, so long as the body 12 can be attached to a complementary medical training device, and in particular the MITS™ Platform P, and position at least a portion of the training area A of the insertion plate 14 over the orifice O.

Thus, it is understood that the insertion plate 14 is preferably designed to be a removable or “replacement” part, such that once a number of training insertions have been made, the “used” plate 14 can be removed and replaced with a “fresh” plate. However, the modular adjunct 10 need not have this feature. Rather, the modular adjunct 10 may alternatively be configured such that the insertion plate 14 is integral with the body 12 as a single component such that, for example, the IO drill, such as the drill I, can be used directly on the single “combined” adjunct 10.

Although the modular adjunct 10 preferably attaches to a training device (such as for example, the MITS™ Platform P) so as to align at least a portion of the training area A of the insertion plate 14 with the training orifice O, the modular adjunct 10 may alternatively be configured such that a portion of the training area A instead aligns with a different orifice or opening in the training device that may not necessarily be designed for training purposes—so long as such a configuration allows proper IO Infusion training on such training device as discussed herein.

While the MITS™ Platform P is depicted by preference as cylindrical, it is contemplated that the MITS™ Platform P may be of a wide variety of other shapes and sizes. For example, the MITS™ Platform P may for example be box-shaped, oval, hexagonal or polygonal. In such circumstances, the modular adjunct 10 can be modified or adapted to releasably attach to any such variety or configuration of the MITS™ Platform P, so long as the modular adjunct 10 can be configured such that at least a portion of the training area A aligns with an in the training device in a position and manner that allows a user to practice IO Infusion training on the device when so positioned.

Depending upon the shape and configuration of the training devices to which the modular adjunct 10 attaches, and the orientation of the orifices or openings in such devices, the modular adjunct 10 may have differing contours and shapes and sizes to accommodate accurate positioning of the adjunct 10 onto the trainer to properly correspond to and mate with such orifices or openings in the trainer.

In addition, other components or features can be added to adjunct 10 to provide more anatomical accuracy. For example, the shape, texture and/or color of the body 12 and/or the insertion plate 14 may be altered to reflect differences within the norm of human bone features.

Further, although the adjunct 10 is configured with two flanges 16 that form a “clip” 18 therebetween, the adjunct 10 can be configured with a variety of fasteners or attachment devices (such as for example a clamp, a latch, a hook, a screw, a biasing member, a grip, a pin, a sling, a hitch, a rivet, a bolt, an anchor, a snap, etc.), so long as any such attachment device is capable of properly attaching the body 12 to a corresponding medical training device (such as for example the MITS™ Platform P) to enable the adjunct to be utilized as described herein.

The descriptions herein are merely exemplary in nature and, thus, variations that do not depart from the gist of that which is described are intended to be within the scope of the teachings. Such variations are not to be regarded as a departure from the spirit and scope of the teachings.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the representative embodiments and implementations described above without departing from the scope of the disclosure. Accordingly, all matter contained in the above description or shown in the accompanying drawings should be interpreted as illustrative and not in a limiting sense.

It is further to be understood that any processes or steps described herein are not to be construed as necessarily requiring their performance in the particular order discussed or illustrated. It is also to be understood that additional or alternative processes or steps may be employed.

What is claimed is:

1. A modular Intraosseous Infusion training adjunct for attachment to a medical training device, said medical training device having an orifice therein, said adjunct comprising a body, said body having a substantially rigid insertion training area constructed to replicate human bone tissue, said body further having an attachment feature, said attachment feature attaching said body to said medical training device, said attachment feature being configured to position said insertion training area, at least in part, over said medical device orifice when said adjunct is attached to said training device.

2. The modular Intraosseous Infusion training adjunct of claim 1, wherein said attachment feature comprises one of a clamp, a latch, a hook, a screw, a biasing member, a grip, a pin, a sling, a hitch, a rivet, a bolt, an anchor, and a snap.

3. The modular Intraosseous Infusion training adjunct of claim 1, wherein said attachment feature releasably attaches to said training device.

4. The modular Intraosseous Infusion training adjunct of claim 1, wherein said training device is configured to utilize said orifice for a medical training procedure.

5. The modular Intraosseous Infusion training adjunct of claim 1, further comprising simulated skin, said simulated skin being positioned at least in part over said insertion training area.

6. The modular Intraosseous Infusion training adjunct of claim 1, wherein said training device comprises a MITS™ Platform.

7. A modular Intraosseous Infusion training adjunct for attachment to a medical training device, said medical training device having an orifice, said adjunct comprising:
a. a body comprising an attachment device, said attachment device attaching said body to said medical training device; and
b. an insertion plate, said insertion plate attaching to said body, said insertion plate comprising a substantially rigid training area constructed to replicate human bone tissue;
wherein said body is configured to position said insertion plate training area, at least in part, over said orifice.

8. The modular Intraosseous Infusion training adjunct of claim 7, wherein said attachment feature comprises one of a clamp, a latch, a hook, a screw, a biasing member, a grip, a pin, a sling, a hitch, a rivet, a bolt, an anchor, and a snap.

9. The modular Intraosseous Infusion training adjunct of claim 7, wherein said attachment feature releasably attaches to said body to said training device.

10. The modular Intraosseous Infusion training adjunct of claim 7, wherein said insertion plate releasably attaches to said body.

11. The modular Intraosseous Infusion training adjunct of claim 7, further comprising simulated skin, said simulated skin being positioned at least in part over said insertion plate training area.

12. The modular Intraosseous Infusion training adjunct of claim 11, wherein said simulated skin attaches to said medical training device.

13. The modular Intraosseous Infusion training adjunct of claim 7, wherein said training device is configured to utilize said orifice for a medical training procedure.

14. The modular Intraosseous Infusion training adjunct of claim 7, wherein said body comprises a longitudinal slot, said longitudinal slot being configured to releasably receive, at least in part, said injection plate.

15. The modular Intraosseous Infusion training adjunct of claim 7, wherein said attachment device comprises a clip, said clip having two opposing tabs, said opposing tabs clamping to said training device there between.

16. The modular Intraosseous Infusion training adjunct of claim 7, wherein said body comprises a positioning tab, said positioning tab engaging a feature of said training device to properly orient said body on said training device.

17. The modular Intraosseous Infusion training adjunct of claim 16, wherein said positioning tab configured to engage said training device orifice to properly orient said body on said training device.

18. The modular Intraosseous Infusion training adjunct of claim 7, wherein said insertion plate and said body collectively forming a simulated human bone segment.

19. The modular Intraosseous Infusion training adjunct of claim 7, wherein said insertion plate and said clip collectively form a simulated human bone segment.

20. The modular Intraosseous Infusion training adjunct of claim 7, wherein said training device comprises a MITS™ Platform.
